(19) United States
(12) Patent Application Publication
(10) Pub. No.: US 2020/0123703 A1
(43) Pub. Date: Apr. 23, 2020

(54) METHOD OF REDUCING FRETTING OF STEEL ROPES AND BELTS

(71) Applicants: ThyssenKrupp Elevator Corporation, Alpharetta, GA (US); thyssenkrupp AG, Essen (DE)

(72) Inventor: Rory Stephen Smith, El Cajon, CA (US)

(73) Assignees: ThyssenKrupp Elevator Corporation, Alpharetta, GA (US); thyssenkrupp AG, Essen (DE)

(21) Appl. No.: 16/163,234

(22) Filed: Oct. 17, 2018

(51) Int. Cl. D07B 1/06; D07B 1/22; B66B 7/06; B66B 9/00; B66B 7/12

(52) U.S. Cl. CPC D07B 1/068; D07B 2201/2066; B66B 7/062; B66B 9/00; B66B 7/06; B66B 7/1284; D07B 2501/2007; D07B 2401/2025; D07B 2401/207; D07B 2205/3025; D07B 2201/104; D07B 2201/2012; D07B 2201/2011; D07B 2201/2009; D07B 2201/2023; D07B 1/22

(57) ABSTRACT

A load-bearing member includes a core including a first plurality of steel wires. Each of the first plurality of steel wires have a benign metallic layer disposed thereon and a low friction coating disposed over the benign metallic layer. A plurality of outer strands surrounds the core. The plurality of outer strands includes a second plurality of steel wires. Each of the second plurality of steel wires have a benign metallic layer disposed thereon. Each of the plurality of outer strands includes a plurality of outer strand inner wires surrounded by a plurality of outer strand outer wires and each of the outer strand inner wires includes a low friction coating.

### FIELD

This disclosure relates to the reduction of fretting of load-bearing members such as steel cables, ropes, and belts.

### BACKGROUND

Construction of traditional wire ropes for use in elevator systems, for example, typically includes wrapping strands of steel wire wound around a natural fiber core. Over time, the breaking strength of traditional elevator ropes is reduced due to bending fatigue and abrasive wear between the rope and the elevator sheave. The abrasive wear may include a process known as fretting.

Fretting refers to wear at the asperities of contact surfaces and sometimes corrosion damage. This damage is induced under load and in the presence of repeated relative surface motion, as induced for example by vibration. The ASM Handbook on Fatigue and Fracture defines fretting as: “A special wear process that occurs at the contact area between two materials under load and subject to minute relative motion by vibration or some other force.” Fretting tangibly downgrades the surface layer quality producing increased surface roughness and micropits, which reduces the fatigue strength of the components.

If adjacent contact surfaces are iron or steel the debris produced in the area of high load oxidizes. The iron oxide thus produced is red and in the case of elevator ropes is referred to as rouge. Rouge is an appropriate name because the oxide is the same material as the abrasive compound known as “Jeweler's Rouge”. The oxidized iron is harder than the steel ropes and causes additional and accelerated abrasive wear to the wires.

Fretting in traditional ropes can be controlled to an extent by lubrication. The fiber core may be saturated with oil. Ropes are routinely maintained after installation by being further lubricated to replenish the oil in the core as well as on the surface of the rope that is lost due to evaporation. For purposes of this application lubrication and/or lubricant will refer to liquid lubricants such as oil and semi-solid lubricants such as grease. Also, the term lubricant will refer to friction reducing materials that flow, such as graphite and the like. When iron oxide is produced by fretting and the rope includes a liquid or semi-liquid lubricant, the combination is a highly abrasive paste that tends to remain in contact with the elements of the rope.

The elevator industry currently prefers to use a type of wire rope known as independent wire rope core (IWRC). IRWC ropes use steel materials that have a relatively higher strength compared to traditional ropes and have a load-bearing core in lieu of a fiber core.

However, these ropes exhibit failure due to fretting due at least to the all steel wire construction. IRWC ropes are typically only lubricated on their surfaces and because of the dense construction of such ropes, it is difficult or impossible to replace the lost lubricant so as to have an effect on fretting. While the average life expectancy of fiber core ropes is around 20 years, IWRC ropes are typically replaced after three to five years. Replacement of ropes is expensive and time consuming. Coated steel belts include strands of high strength steel wires encased in polyurethane. The wires of these types of load-bearing elements are not lubricated and also fail by fretting.

Therefore, there is a need for steel wire ropes and the like that exhibit reduced fretting and increased life span.

### SUMMARY

In one embodiment, a load-bearing member includes a core including a first plurality of steel wires. Each of the first plurality of steel wires have a benign metallic layer disposed thereon and a low friction coating disposed over the benign metallic layer. A plurality of outer strands surrounds the core. The plurality of outer strands includes a second plurality of steel wires. Each of the second plurality of steel wires have a benign metallic layer disposed thereon. Each of the plurality of outer strands includes a plurality of outer strand inner wires surrounded by a plurality of outer strand outer wires and each of only the outer strand inner wires include a low friction coating.

### BRIEF DESCRIPTION OF THE DRAWINGS

The present disclosure is described in detail below with reference to the attached drawing figures, wherein:

FIG. 1 is a general view of an elevator system including a load-bearing member according to an embodiment of the disclosure.

FIG. 2 is a cross sectional view of a load-bearing member according to an embodiment of the disclosure.

FIG. 3 is a cross sectional view of a load-bearing member according to another embodiment of the disclosure.

### DETAILED DESCRIPTION

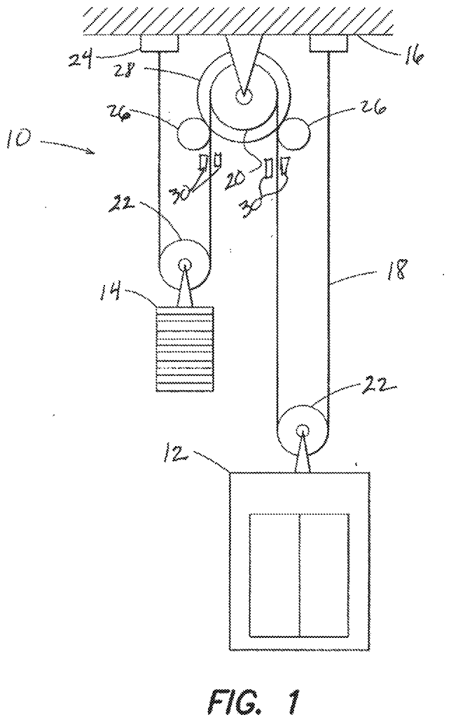

In its most general form, and referring to FIG. 1, an elevator system 10 according to one embodiment includes an elevator car 12 and a counterweight 14 diagrammatically shown within a hoistway 16, connected to one another by one or more flexible load-bearing members 18. The load-bearing members 18 are shown extending in a 2:1 roping configuration, wherein the members pass over a drive sheave 20, drop to the elevator car 12 or counterweight 14, and subsequently wrap around another unpowered sheave(s) 22 attached to the respective car or counterweight before returning to an anchor position 24 at the top of the hoistway 16. Frictional engagement (i.e., traction) between the drive sheave 20 and load-bearing member 18 enables the drive sheave to move the load-bearing member and therefore the attached elevator car 12 and counterweight 14. The load-bearing members 18 may also be wire ropes as detailed in this application. The drive sheave 20 is driven by motor 28. The system 10 may include brushes 30 that are positioned so as to bear against load-bearing member 18 and remove dust, contaminants, and wear debris as will be explained more fully herein. The placement of the brushes 30 may be any suitable position and provided as a single brush, a pair of brushes, a plurality of brushes or any suitable arrangement, configuration, or number of brushes.

The configuration of the sheaves 20, 22 will subject the load-bearing member 18 to reverse curvatures when the load-bearing members engage the crowned sheaves. To prevent mis-tracking as the load-bearing members 18 enter sheave 20, it is known to use flat rollers 26 with low friction coating positioned adjacent to the drive sheave to reconfigure the load-bearing member(s). The grooves of the unpowered sheaves 22 within the 2:1 system are typically coated with a durable, low friction material to prevent/minimize tension imbalance between the load-bearing members 18. Some acceptable coating materials for the sheaves 22 include polypropylene or polyethylene, or alternatively the entire sheave can be made from high hardness Nylon with friction-reducing additives. It will be understood that the presently illustrated elevator system 10 is for illustration purposes and any configuration of similar elements or similar functional aspects using a load-bearing member or members 18 as described herein is contemplated.

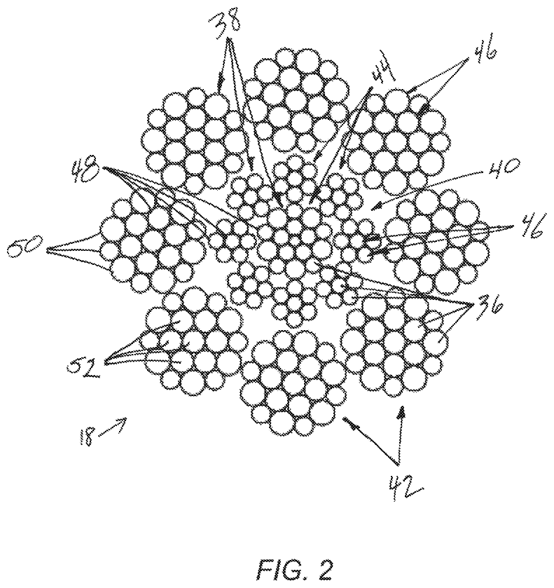

Turning to FIG. 2, a load-bearing member 18 in the form of a wire rope is formed by twisting steel wires 36 together to form strands 38 and further twisting the strands together. In the case of an IWRC rope, steel wires 36 are configured into a rope core 40 surrounded with outer strands 42, which are wound or twisted around the core, to form the complete rope.

IRWC ropes in particular have been used as a running rope in a wide range of mechanical systems including the illustrated elevator system 10 by being wound around or caught in a sheave because of its flexibility. The rope, made of steel, is a consumable part, so that extension of its life contributes to improvement of reliability and safety. To reduce possible fatigue and abrasion due to repeated bending of the rope upon passing around the sheave, the repeated bending being one of the factors affecting the life of the steel rope, the ratio (D/d) of the sheave diameter D to the rope diameter d is set at a certain value or more (for elevators, this value is set at 40 or more) according to the mechanical system.

Reduction of the sheave diameter contributes to reduce the size, space, and cost of the mechanical system. To minimize the adverse effects of the factors concerning the life of the rope, the rope of the present disclosure may be constructed as shown in FIG. 2. Wire ropes, and in particular IWRC ropes, have steel wires that are twisted together to form strands, which strands are twisted together in a well-known fashion. One example of a rope construction suitable for use in the present system 10 is an 8×19 W—IRWC rope.

The load-bearing member 18 therefore may generally include a wire rope core 40 and a plurality of outer strands 42 wound about and surrounding the core. The core 40 may include a plurality of core strands 44 or a combination of core strands and untwisted wire(s) according to the wire construction specified for an intended end use. The outer strands 42 include outer strand outer wires 50 and outer strand inner wires 52 disposed inside of the outer strand outer wires and surrounded thereby.

All of the wire components of the core 40 and the outer strands 42 are provided with a metallic layer, plating, or coating 46. The metal layer 46 is nonferrous and of a material whose oxide is nonabrasive, or at least less hard than iron oxide (e.g., having a lower Mohs hardness), and preferably less hard than the steel used for the wire. For purposes of the present disclosure, the metal layer 46 will also be referred to as a benign metallic layer.

One example of a material suitable for the benign metallic layer 46 is nickel. The nickel layer may be disposed onto the steel wire by electroplating or an electro-less process, for example. Any suitable method of applying the metal layer 46 onto the wires is contemplated. The purpose of the benign metallic layer 46 is to provide an outer, exposed, metallic layer that will not oxidize into an abrasive such as iron oxide. The wear debris in a wire rope is initially asperities. When these asperities are plated with a benign metallic layer, the majority of the surface of the asperities will be nonferrous and as a result, it is believed that a smaller volume of iron oxide will be produced during operation of the system, which reduces fretting.

The benign metallic layer 46 may be any other suitable non-ferrous metallic layer such as bronze, metal alloys, and may include one or more than one layer of metallic material. One characteristic that makes nickel especially useful in the present application is that nickel is a good diffusion barrier to iron. Therefore, the benign metallic layer 46 should exhibit a good barrier to iron from the wire cores diffusing through the layer and producing iron oxides, and, in addition, the material of the layer should not produce significant wear from the contact and vibrations of adjacent wires.

Some or all of the wires 36 that are provided with the benign layer 46 may be further coated with a low friction coating 48 such as polytetrafluoroethylene (PTFE). The low friction coating 48 may be any suitable low friction coating for use on the plated wires. Other examples of the low friction coating include other fluoropolymers, fluoropolymer hybrids, polyurethanes, molybdenum disulfide, PTFE/graphite, Nylon, or any other suitable low friction materials or combinations of such materials.

All of the wires of the rope core 40 are each coated with the low friction coating 48. The low friction coating 48 may be omitted from outer wires 50 of the outer strands 42. Omitting the low friction coating 48 from the outer strand outer wires 50 provides a desirable amount of friction between the load-bearing member 18 and the drive sheave 20. While the system 10 may operate with a load-bearing member 18 with all of the wires provided with the low friction coating 48, omitting the low friction coating from the outer wires 50 may be preferred.

The low friction coating 48 modifies the movement between wires 36 and strands 38 from vibrational to sliding. It is believed that presence of the low friction coating 48 and the resulting modification to the interactions between the components of the load-bearing member 18 will delay the onset of the vibration mode until the low friction material is worn off thus extending the safe operational life of the load-bearing member 18.

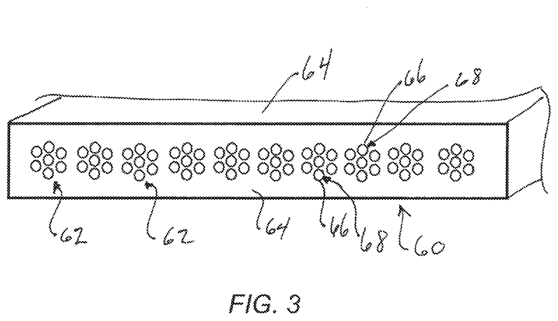

FIG. 3 is a further simplified embodiment of a load-bearing member 60 in the form of a coated steel belt. Coated steel belts are used in elevator systems as the load-bearing member. The load-bearing member 60 has a flat belt configuration with a plurality of steel wire ropes 62 fully embedded in a flat polyurethane belt body 64 as is well-known. The steel wire ropes 62 may be composed of individual wires, strands, or combinations of wires and strands as is well known. It will be understood that the number of ropes 62 and overall configuration of the load-bearing member 60 may be constructed to be suitably used in an elevator system 10 as illustrated above, for example.

As detailed in the above embodiment of FIG. 2, the wires of ropes 62 may be individually plated with a benign metallic layer 66. In addition, since traction is provided by the material of the polyurethane belt body 64, all the wires are further overcoated with a low-friction material 68, such as PTFE. The benign metallic layer 66 and overcoating of low-friction material 68 has the object of reducing wear and increasing the useful life of the load-bearing member 60.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A load-bearing member, comprising:
a core including a first plurality of steel wires, each of the first plurality of steel wires having a benign metallic layer disposed thereon, and a low friction coating disposed over the benign metallic layer; and
a plurality of outer strands surrounding the core, the plurality of outer strands including a second plurality of steel wires, each of the second plurality of steel wires having a benign metallic layer disposed thereon;
wherein each of the plurality of outer strands includes a plurality of outer strand inner wires surrounded by a plurality of outer strand outer wires, each of the outer strand inner wires including a low friction coating.

2. The load-bearing member of claim 1, wherein only the outer strand inner wires of the outer strands include the low friction coating.

3. The load-bearing member of claim 2, wherein the low friction coating includes PTFE.

4. The load-bearing member of claim 1, wherein the load-bearing member is free of lubricant.

5. The load-bearing member of claim 1, wherein the load-bearing member is a wire rope.

6. The load-bearing member of claim 5, wherein the wire rope is an independent wire rope core rope.

7. The load-bearing member of claim 1, wherein the load-bearing member is a flat belt.

8. The load-bearing member of claim 1, wherein the benign metallic coating includes nickel.

9. The load bearing member of claim 1, wherein the benign metallic coating forms a diffusion barrier.

10. An elevator system, comprising:
an elevator car;
a load-bearing member including a core including a first plurality of steel wires, each of the first plurality of steel wires having a benign metallic layer disposed thereon, and a low friction coating disposed over the benign metallic layer; and
a plurality of outer strands surrounding the core, the plurality of outer strands including a second plurality of steel wires, each of the second plurality of steel wires having a benign metallic layer disposed thereon;
wherein each of the plurality of outer strands includes a plurality of outer strand inner wires surrounded by a plurality of outer strand outer wires, each of the outer strand inner wires including a low friction coating;
a drive motor configured to displace the rope and move the car;
one or more sheaves configured to guide the displacement of the rope; and
a counterweight coupled to the rope and configured to counterbalance the weight of the car.

11. The system of claim 10, wherein only the outer strand inner wires of the outer strands include the low friction coating.

12. The system of claim 11, wherein the low friction coating includes PTFE.

13. The system of claim 10, wherein the load-bearing member is free of lubricant.

14. The system of claim 10, wherein the load-bearing member is a wire rope.

15. The system of claim 14, wherein the wire rope is an independent wire rope core rope.

16. The system of claim 10, wherein the load-bearing member is a flat belt.

17. The system of claim 10, wherein the benign metallic coating includes nickel.

18. The system of claim 10, further comprising one or more brushes disposed contactingly adjacent the load-bearing member for removing debris therefrom.
